(19) United States
(12) Patent Application Publication
(10) Pub. No.: US 2007/0041647 A1
(43) Pub. Date: Feb. 22, 2007

(54) Method for increasing the flexibility of DICOM tags management in application-specific integration

(76) Inventors: Charles Florin, Princeton, NJ (US); Mazen El Bawab, Montreal (CA); Fred S. Azar, Princeton, NJ (US); Romain Moreau-Gobard, Palo Alto, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/486,666

(22) Filed: Jul. 14, 2006

Related U.S. Application Data
(60) Provisional application No. 60/702,103, filed on Jul. 22, 2005.

(51) Int. Cl. G06K 9/36

(52) U.S. Cl. 382/233

(57) ABSTRACT

A method of importing an image from an image file, including the steps of reading an image data portion and a header portion from the image file, retrieving essential tag names from a table, and upon verifying that the header portion includes all of the essential tag names, retrieving the image from the image data portion.

### CROSS-REFERENCE TO RELATED APPLICATIONS

This application claims priority to U.S. Provisional Application No. 60/702,103, filed on Jul. 22, 2005, the disclosure of which is incorporated by reference herein.

### BACKGROUND OF THE INVENTION

1. Technical Field

The present disclosure relates generally to the field of medical imaging, and, more particularly, to the management of medical imaging files.

2. Discussion of the Related Art

The Digital Imaging and Communication in Medicine (DICOM) standard describes a file format for media storage and image distributions. The standard was created by the National Electrical Manufacturers Association (NEMA) to aid the distribution and viewing of medical images, such as CT scans, MRIs, and ultrasound. The DICOM format consists of a header portion and an image data portion.

FIG. 1 illustrates a hypothetical DICOM image file 100 generated from an MRI scan. Referring to FIG. 1, the header portion 101 contains information about the image data portion 102. Only a small subset of DICOM header tags which are available in the DICOM format are illustrated. Although the header portion is illustrated as being 794 bytes in length, the header size may vary depending on the image type (e.g., MRI, PET) and how much information is stored. Here, the header defines an image, which has the dimensions 109×91×2 voxels, with a data resolution of 1 byte per voxel (so the total image size will be 19838 bytes). The image data follows the header information and both are stored in the same file.

FIG. 2 illustrates an example of a typical DICOM header. The first 128 bytes of the DICOM header are known as the preamble and are typically set to all zeros. The characters ‘D’, ‘I’, ‘C’, and ‘M’ follow the preamble. The characters are followed by additional header information, which is organized into groups. Referring to FIG.2, the group 0008 hex is an identifying group, and contains 3 tags, one that defines a group length, one that defines a modality of the imaging device used, and a one that defines the manufacturer of the imaging device used. The DICOM format uses a series of pre-defined tags, and allows the definition of new tags, which may or may not be present for a given dataset. This flexibility is one of the features that made the DICOM format so popular for medical imaging. Nevertheless, this popularity had led to the multiplication of tag definitions, and consequently, it is sometimes difficult to know which tags are used, and what they mean, making the extraction of header information more difficult. New medical imaging technologies are often developed in academic settings, each using unique customized hardware and proprietary image formats. The number of tags, which may or may not be present, makes import/export tools increasingly complex for integration in medical imaging applications. Consequently, the import/export tools tend to be more application specific, thus limiting the portability for other applications and platforms.

There exists a need for a more efficient method of importing and exporting DICOM image files.

### SUMMARY OF THE INVENTION

An exemplary embodiment of the present invention provides a method of importing an image from an image file. The method includes the steps of reading an image data portion and a header portion from the image file, retrieving essential tag names from a table, and upon verifying that the header portion includes all of the essential tag names, retrieving the image from the image data portion.

An exemplary embodiment of the present invention provides a computer readable medium including computer code for importing an image of an image file. The computer readable medium includes computer code for reading an image data portion and a header portion from the image file, computer code for retrieving essential tag names from a table, and computer code that retrieves the image from the image data portion after verifying that the header portion includes all of the essential tag names

An exemplary embodiment of the present invention provides a method for collating images into an image volume. The method includes the steps of retrieving a set of volume identifiers and a corresponding set of volume identifier values from a map, and when it is determined that all of the volume identifiers are present within a first image and a second image, retrieving a first set of volume identifier values from the first image and a second set of volume identifier values from the second image, and collating the first image and the second image into the image volume when each of the first set of volume identifier values matches one of the second set of volume identifier values. The first set of volume identifier values and the second set of volume identifier values each correspond to the volume identifiers.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a hypothetical DICOM image file generated from an MRI scan.

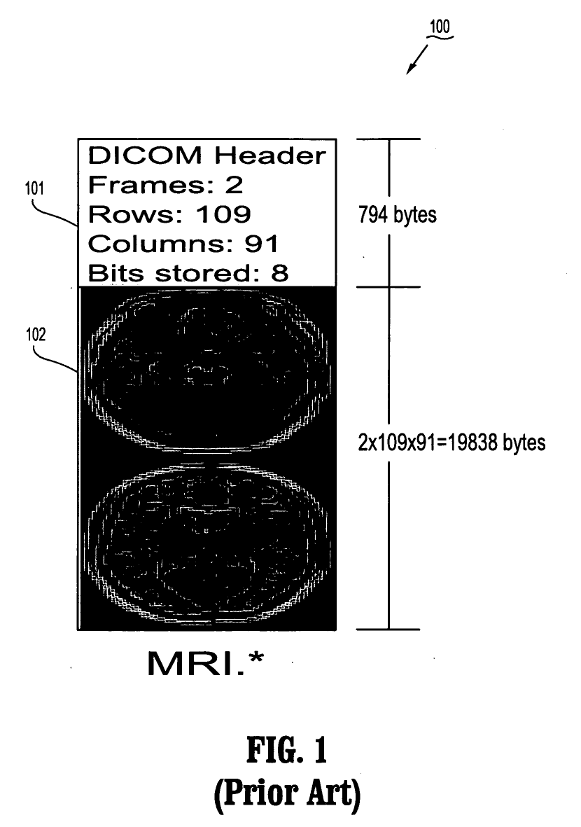

FIG. 2 illustrates an example of a typical DICOM header.

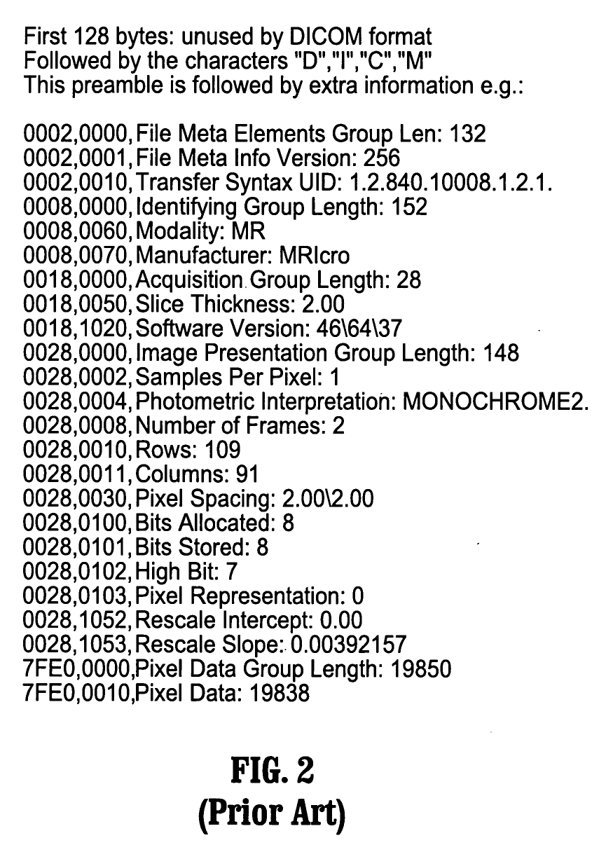

FIG. 3 illustrates a method of importing an image from an image file according to an exemplary embodiment of the present invention.

FIG. 4 illustrates an exemplary embodiment of a tag table referenced in FIG. 3.

FIG. 5 illustrates a method of importing an image from an image file according to an exemplary embodiment of the present invention.

### DETAILED DESCRIPTION OF EXEMPLARY EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

Due to the need for a more efficient method of importing and exporting DICOM image files, we propose a new flexible method, which allows the user to select/define a set of application-specific tags, out of a tags dictionary. This method thus takes full advantage of DICOM flexibility, and allows the user/developer to customize an initialization file specific to his/her application. This file specifies the way by which DICOM volumes are differentiated, ordered, and labeled. The user-defined initialization file also supports the addition of private tags, which are not defined in the DICOM standard or in the proposed tags dictionary, thus providing the user with added flexibility.

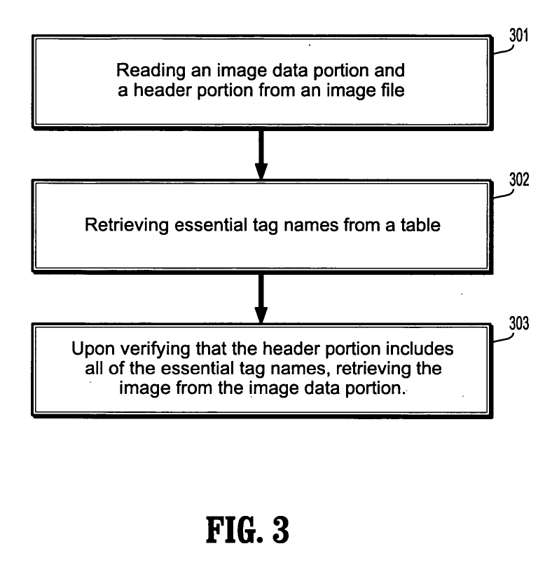

FIG.3 illustrates a method of importing an image from an image file according to an exemplary embodiment of the present invention.

Referring to FIG. 3, the method includes the steps of reading an image data portion and a header portion from the image file 301, retrieving essential tag names from a tag table 302, and upon verifying that the header portion includes all of the essential tag names, retrieving the image from the image data portion 303.

The image file illustrated in FIG. 3 preferably has a DICOM format. A header portion of a valid DICOM file has a 128 byte preamble followed by the letters ‘D’, ‘I’, ‘C’, and ‘M’. If the preamble and letters are not both present, the file will not be recognized as a DICOM file and importation will fail. When the preamble and letters are present, importation can proceed. All DICOM files with essential tag names that match those retrieved from the table can be correctly imported.

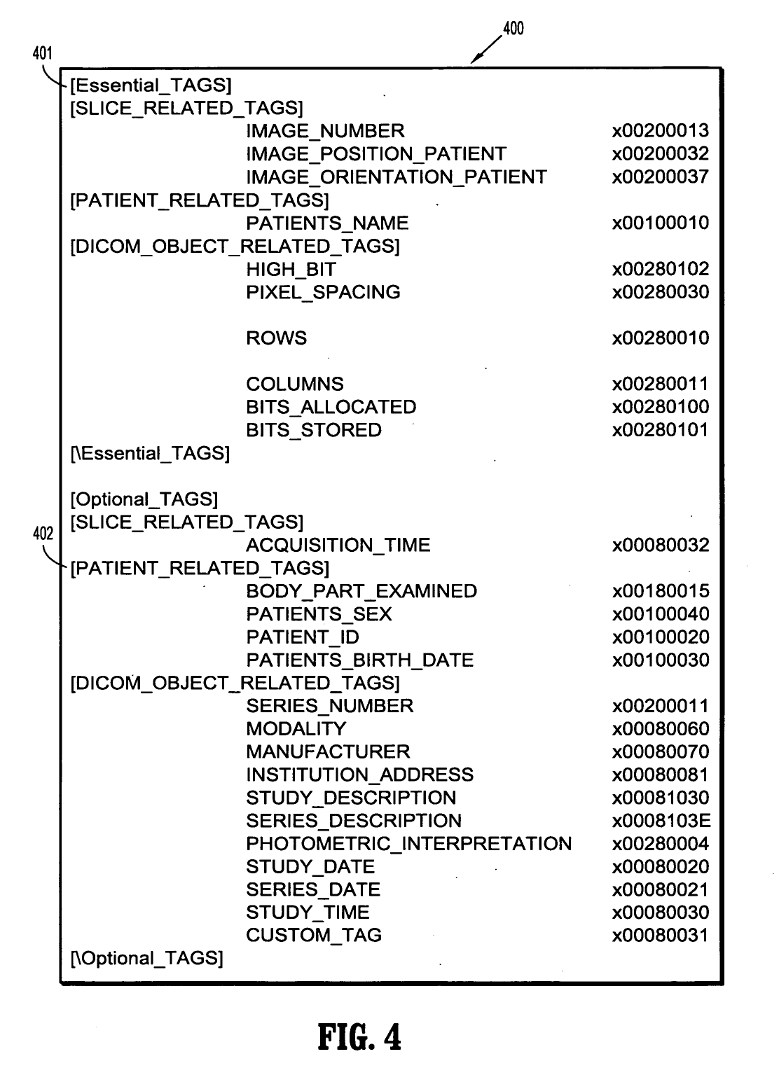

FIG. 4 illustrates an exemplary embodiment of the tag table referenced in FIG. 3.

Referring to FIG. 4, the tag table 400 may be stored in a file known as a tag initialization file. The tag table 400 is organized into a number of sections. Each section contains a number of tag names and corresponding tag values. A tag name is a label for an attribute of a particular image dataset. A tag value represents the contents of an attribute with a name of the tag name.

The tag table has a number of sections, including an essential tags section 401 labeled “Essential_TAGS” and an optional tags section 402 labeled “Optional_TAGS”. The essential tags section is organized into a number of related essential tag sections, namely “SLICE_RELATED_TAGS”, “PATIENT_RELATED_TAGS”, and “DICOM_OBJECT_RELATED_TAGS. Although three essential tags sections are illustrated in FIG.4, this is merely an exemplary embodiment of the tag table 400 and any number of sections may be used. The “SLICE_RELATED_TAGS” essential tag section contains essential tags that relate to image slices. Since a 3D image can be broken up into a series of 2D slices which may be stored in separate files, it is important to store information about slice ordering so the 3D image can be reconstructed. The “PATIENT_RELATED_TAGS” essential tag section contains essential tags that relate to the patient that the imaging scan was performed on. The “DICOM_OBJECT_RELATED_TAGS” essential tags section contains essential tags about the image data contained within the DICOM file. As an example, it includes essential tags “ROWS” and “COLUMNS” which are the number of rows and columns of data stored within the image data portion of the DICOM file.

Each of the essential tags include a tag name and a corresponding tag value. The tag values may be encoded numeric values or addresses which can later be translated into their textual representations by use of a data dictionary or a look-up table. As an example, in FIG. 4, the essential tag “PATIENTS_NAME” has an tag value of x00100010. If this value were entered into an appropriate look-up table, a textual representation of “John Doe” could be returned.

Essential tags are required by a particular reader application to properly read in a DICOM file. A typical reader application contains a hard-coded list of these essential tags. When a DICOM file without matching essential tags is loaded by a typical reader application, the load will usually fail. However, by separating the essential tags for a particular dataset from the reader application into an external tag table, DICOM files from various datasets can be read by the same reader application. A reader application need only load the appropriate tag table, and then read in all DICOM files of that dataset. For DICOM files of another dataset, the reader application would just load the next appropriate tag table.

The optional tags section 402 includes optional tags which contain additional information about the image that are not considered essential to the loading of the image by a reader application. Although the optional tags section 402, illustrated in FIG. 4, contains sections with the same headings as the essential tags section 401, the present invention is not limited thereto, as various other section headings may be used. Examples of optional tags include ACQUISITION_TIME, PATIENTS_SEX, and MANUFACTURER. The optional tags may also include a user customizable tag, illustrated in FIG.4 as “CUSTOM_TAG”. User customizable tags are used to store information that is not currently supported by the DICOM format.

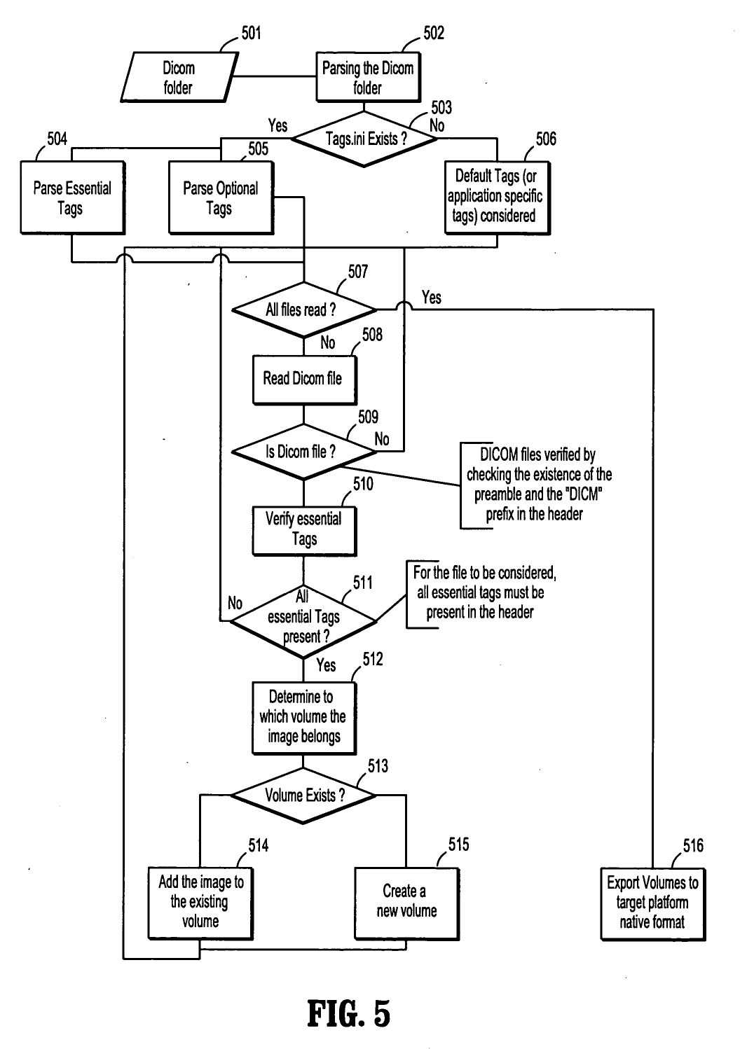

FIG. 5 illustrates a method of importing an image from an image file according to an exemplary embodiment of the present invention.

Referring to FIG. 5, the method starts when a user navigates to a DICOM folder 501. The folder includes image files in a DICOM format and may include a tag initialization file that was previously customized to be specific to a DICOM dataset of interest. Then the DICOM folder is parsed for files 502. It is then determined whether a tag initialization file is present 503 in the DICOM folder. If the tag initialization file is not present, a set of pre-defined application-specific tags are used as default essential tags 506. This default set of tags may be customized by the user. If the tag initialization file is present, essential tags are retrieved by parsing the tag initialization file for the essential tags 504 and optional tags are retrieved by parsing the tag initialization file for optional tags 505.

An image file is then read from the DICOM directory 508. A header portion of the image file is then parsed to determine whether the file is of a DICOM format 509. The image file is determined to be of a DICOM format if it has a DICOM preamble followed by the letters ‘D’, ‘I’,‘C’, and ‘M’. If the image file is not determined to-be of a DICOM format, a next image file is read from the DICOM directory 508.

If the image file is of the DICOM format, the header portion of the image file is parsed to determine which essential tags of the tag initialization file are present 510. Then it is determined whether all of the essential tags of the tag initialization file are present within the header portion of the image file 511. If not all of the essential tags are present in the header portion of the DICOM file, a next image file is read from the DICOM directory 508.

If each of the essential tags are present in the header portion of the DICOM file, a volume to which the DICOM file belongs is determined 512. The volume is determined by examining the essential tags. A volume may be distinguished from another by the contents of its essential tags. Two DICOM files are part of the same DICOM dataset when they have the same essential tag names. In this way, several DICOM files may be read in using a single tag initialization file even though they may each belong to a different DICOM volume. Two DICOM files are part of the same DICOM volume when they have the same essential tag names and the same corresponding essential tag values. As an example, assume a first and a second DICOM file have all the same essential tag names, including the tag name of PATIENTS_NAME. However, if the first DICOM file's PATIENTS_NAME is set to a value of John and the second DICOM file's PATIENTS_NAME is set to a value of Jane, the first and second DICOM files are part of two different DICOM volumes.

Once it is determined to which volume the DICOM file belongs, it is determined whether an existing DICOM volume exists 513. If the existing DICOM volume has been previously generated, the image of the DICOM file is added to the existing DICOM volume 514. If the existing DICOM volume has not been generated, a new DICOM volume is created and the image is added to the new DICOM volume 515. The method is repeated until it is determined that all files in the DICOM folder have been read 507. When all the files have been read, all the volumes can then be exported into a format that is native to the platform of an application that will display the volumes 516.

A tag initialization file can also be used in the generation or export of one or more DICOM files. A typical imaging device performs a scan and generates an image file in a format that is native to the device. A separate writer application is often used to convert the image file from its native format to one or more DICOM formatted files. The writer application may be modified to additionally write out a tag initialization file which corresponds to the DICOM formatted file. Then the method illustrated in FIG. 5 can be used to import the DICOM formatted files. In the alternative, a user can generate a tag initialization file to be used by the writer application. The user would have edited the tag initialization file to contain essential tags, optional tags, and user-defined tags. The writer application would then be modified to use the tags of the tag initialization file to write out DICOM formatted files containing those tags. These newly formatted DICOM files could then be imported by the method illustrated in FIG. 5.

Exemplary embodiments of the present invention are flexible enough to be used in various contexts, such as imaging modalities (e.g., perfusion or angiography), application specific data (e.g., contour sequences for image segmentation), and novel imaging modalities (e.g., molecular or optical imaging). A relevant example in the practical use of an exemplary embodiment of the present invention is within the official NTROI (Network for Translational Research in Optical Imaging) imaging software platform. As a member of the NTROI, Siemens Corporate Research (SCR), is developing the Optical and Multimodal Imaging Platform for Research, Assessment and Diagnosis (OMNIAAD). A major goal of this platform is to enable multimodal integration and visualization of diffuse optical tomography (DOT) and other known imaging modalities (MRI, X-ray) in breast cancer imaging. One of the challenges in implementing the OMNIRAD platform is how to represent and store the DOT image format along with numerous parameters for image acquisition and 3D construction. A popular format known as Time-resolved Optical Absorption and Scattering Tomography (TOAST) is widely used today for DOT image reconstruction. The OMNIRAD platform uses TOAST for the import of DOT data. The import and export methods disclosed by exemplary embodiments of the present invention enable the export of the DOT volume to DICOM format through user-defined tags, thus bringing an initial “standard” to the DOT image format. The exported DOT data can then be imported by any other DICOM-supporting platform.

Although the exemplary embodiments of the present invention have been described in detail with reference to the accompanying drawings for the purpose of illustration, it is to be understood that the that the inventive processes and systems are not to be construed as limited thereby. It will be readily apparent to those of ordinary skill in the art that various modifications to the foregoing exemplary embodiments can be made therein without departing from the scope of the invention as defined by the appended claims, with equivalents of the claims to be included therein.

What is claimed is:

1. A method of importing an image from an image file, comprising the steps of:
reading an image data portion and a header portion from the image file;
retrieving essential tag names from a table; and
upon verifying that the header portion includes all of the essential tag names, retrieving the image from the image data portion.

2. The method of claim 1, wherein the image file is of a DICOM format.

3. The method of claim 2, wherein the retrieving of the image only occurs when a DICOM preamble and DICM prefix are present within the header portion.

4. The method of claim 1, wherein the table is stored within a tag initialization file.

5. The method of claim 1, wherein the table includes optional tag names and corresponding optional tag values.

6. The method of claim 1, further comprises the steps of:
retrieving image tag values from the header portion that each correspond to the essential tag names;
upon determining that all of the essential tag names are present within an image volume, retrieving volume tag values from the image volume which correspond to the essential tag names; and
adding the image to the image volume when each of the image tag values matches with one of the volume tag values.

7. The method of claim 1, wherein the image volume is of the DICOM format.

8. The method of claim 6, further comprising exporting the image volume to a format that is native to an imaging device.

9. A computer readable medium having program instructions thereto for implementing the method claim in claim 1 when executed in a digital processing device.

10. A computer readable medium including computer code for importing an image of an image file, the computer readable medium comprising:
computer code for reading an image data portion and a header portion from the image file;
computer code for retrieving essential tag names from a table; and
computer code that retrieves the image from the image data portion after verifying that the header portion includes all of the essential tag names.

11. The computer readable medium of claim 12, wherein the image file is of a DICOM format.

12. The computer readable medium of claim 11, wherein the table is stored within a tag initialization file.

13. The computer readable medium of claim 11, further comprising:
computer code for retrieving image tag values from the header portion that each correspond to the essential tag names;
computer code that upon determining that all of the essential tag names are present within an image volume, retrieves volume tag values from the image volume which correspond to the essential tag names; and
computer code for adding the image to the image volume when each of the image tag values matches with one of the volume tag values.

14. A method for collating images into a image volume comprising the steps of:
retrieving a set of volume identifiers and a corresponding set of volume identifier values from a map;
when it is determined that the set of volume identifiers are present within a first image and a second image, retrieving a first set of volume identifier values from the first image and a second set of volume identifier values from the second image, wherein the first set of volume identifier values and the second set of volume identifier values each correspond to the volume identifiers; and
collating the first image and the second image into the image volume when each of the first set of volume identifier values matches one of the second set of volume identifier values.

15. The method of claim 14, wherein the first image file and the second image file are each of a DICOM format.

16. The method of claim 14, wherein the map is stored within an initialization file.
